(19) United States
(12) Patent Application Publication
(10) Pub. No.: US 2015/0193159 A1
(43) Pub. Date: Jul. 9, 2015

(54) STORAGE DEVICE INCLUDING NONVOLATILE SEMICONDUCTOR MEMORY AND MANAGING METHOD THEREOF

(71) Applicant: SAMSUNG ELECTRONICS CO., LTD., Suwon-Si (KR)

(72) Inventors: KeunSoo JO, Hwaseong-si (KR); HeeChang CHO, Seoul (KR); Ilsu HAN, Incheon (KR)

(21) Appl. No.: 14/505,077

(22) Filed: Oct. 2, 2014

(30) Foreign Application Priority Data
Jan. 6, 2014 (KR) 10-2014-0001315

(51) Int. Cl. G06F 3/06

(52) U.S. Cl. CPC G06F 3/0619; G06F 3/0679; G06F 3/0644

(57) ABSTRACT

A storage device includes a memory controller configured to generate mapping information between a plurality of physical partitions and a plurality of logical partitions based on a partition generation signal, the plurality of physical partitions respectively allocated to different physical areas, the plurality of logical partitions respectively mapped with the plurality of physical partitions; and a nonvolatile semiconductor memory including a memory area divided into the plurality of physical partitions based on the generated mapping information, wherein the memory controller is configured such that the plurality of logical partitions respectively mapped with the plurality of physical partitions is uniquely determined by the memory controller based on the generated mapping information, until a partition clearance signal is provided.

### CROSS-REFERENCE TO RELATED APPLICATIONS

A claim for priority under 35 U.S.C. §119 is made to Korean Patent Application No. 10-2014-0001315 filed Jan. 6, 2014, in the Korean Intellectual Property Office, the entire contents of which are hereby incorporated by reference.

### BACKGROUND

1. Technical Field

At least some example embodiments of the inventive concepts relate to a storage device, and more particularly, relate to a storage device for mapping a plurality of physical partitions of a nonvolatile semiconductor memory with a plurality of logical partitions uniquely and a method of managing the same.

2. Discussion of Related Art

Semiconductor memory devices are classified into volatile memory devices and nonvolatile memory devices. A volatile memory device operates at high speed but loses contents stored therein at power-off, whereas a nonvolatile memory device retains contents stored therein even at power-off. Thus, the nonvolatile memory device is used to retain contents stored therein regardless of supplying power or not.

A flash memory device is a widely used nonvolatile semiconductor memory device. The flash memory device is connected to devices such as a computer, a mobile phone, a digital camera, a game console, a printer, a handheld PC, etc. (hereinafter, referred to as a host) to store data. A solid state drive (SSD), a secure digital (SD) card, and an embedded MultiMedia Card (eMMC) are examples of storage devices including one or more flash memories.

Each memory area of the flash memory device is accessed dynamically. For example, pages or blocks of each memory area are accessed according to a sequence calculated by a designed algorithm, regardless of physical arrangement of pages or blocks of each memory area. In some cases, a plurality of logical partitions with respect to the memory areas may be formed, but logically-separated partitions may not be separated physically. That is, although a plurality of logical partitions are formed, physical memory areas may be shared by the plurality of logical partitions.

If the physical memory areas are shared by the plurality of logical partitions, however, there may be a possibility that an integrity of the data is damaged. Furthermore, if the physical memory areas are shared under the condition that access authorities to each of the plurality of logical partitions are granted to different hosts, data may be prone to security breaches.

### SUMMARY

At least some example embodiments of the inventive concepts provide a storage device that includes a memory controller configured to generate mapping information between a plurality of physical partitions and a plurality of logical partitions based on a partition generation signal, the plurality of physical partitions respectively allocated to different physical areas, the plurality of logical partitions respectively mapped with the plurality of physical partitions; and a nonvolatile semiconductor memory including a memory area divided into the plurality of physical partitions based on the generated mapping information, wherein the memory controller is configured such that the plurality of logical partitions respectively mapped with the plurality of physical partitions is uniquely determined by the memory controller based on the generated mapping information, until a partition clearance signal is provided.

According to at least one example embodiment of the inventive concepts, the storage device is configured such that, in response to a first physical partition included in the plurality of physical partitions and a first logical partition included in the plurality of logical partitions being uniquely mapped based on the generated mapping information and a second physical partition included in the plurality of physical partitions and a second logical partition included in the plurality of logical partitions are uniquely mapped based on the generated mapping information, the first logical partition and the second logical partition are only mapped with the first physical partition and the second physical partition, respectively, until the partition clearance signal is provided.

According to at least one example embodiment of the inventive concepts, the storage device is configured to receive a partition generation command and a partition clearance command from a host, and the storage device is configured such that the partition generation signal and the partition clearance signal are generated based on the partition generation command and the partition clearance command, respectively.

According to at least one example embodiment of the inventive concepts, the storage device is configured such that the partition generation signal includes information corresponding to at least one of, a physical address range of a physical area, to which each of the plurality of physical partitions is allocated, and a memory size of each of the plurality of physical partitions.

According to at least one example embodiment of the inventive concepts, the storage device is configured such that the partition generation signal includes information corresponding to one or more memory use characteristics of each of one or more of the plurality of physical partitions.

According to at least one example embodiment of the inventive concepts, the storage device is configured such that the one or more memory use characteristics include at least one of a ratio of an overprovisioning area and a wear level.

According to at least one example embodiment of the inventive concepts, the storage device is configured such that a value of the one or more memory use characteristics of at least one of the plurality of physical partitions is set to be different from that of a physical partition other than the at least one physical partition.

According to at least one example embodiment of the inventive concepts, the storage device is configured such that, based on an access request with respect to an access target logical partition from among the plurality of logical partitions being received at the storage device from a host, the memory controller controls the nonvolatile semiconductor memory such that the access request is processed in an access target physical partition that is uniquely mapped with the access target logical partition, from among the plurality of physical partitions.

According to at least one example embodiment of the inventive concepts, the nonvolatile semiconductor memory further includes at least one of a memory area mapped in common with two or more of the plurality of logical partitions and a memory area accessed regardless of the generated mapping information.

According to at least one example embodiment of the inventive concepts, the memory controller is configured to set an overall memory area of the nonvolatile semiconductor memory to be dynamically accessed, based on the partition clearance signal.

At least some example embodiments of the inventive concepts provide a method of managing a storage device including a nonvolatile semiconductor memory, the method including receiving a partition generation signal; generating mapping information between a plurality of physical partitions and a plurality of logical partitions based on the received partition generation signal, the plurality of physical partitions respectively allocated to different physical areas of the nonvolatile semiconductor memory, the plurality of logical partitions respectively mapped with the plurality of physical partitions; and controlling the nonvolatile semiconductor memory such that a memory area of the nonvolatile semiconductor memory is divided into the plurality of physical partitions based on the generated mapping information, wherein the plurality of logical partitions respectively mapped with the plurality of physical partitions is uniquely determined based on the generated mapping information, until a partition clearance signal is provided.

According to at least one example embodiment of the inventive concepts, the partition generation signal includes information corresponding to at least one of,

a physical address range of a physical area, to which each of the plurality of physical partitions is allocated, and a memory size of each of the plurality of physical partitions.

According to at least one example embodiment of the inventive concepts, the partition generation signal includes information corresponding to a memory use characteristic of each of the plurality of physical partitions.

According to at least one example embodiment of the inventive concepts, the method further includes receiving an access request with respect to an access target logical partition from among the plurality of logical partitions from a host; and controlling the nonvolatile semiconductor memory such that the access request is processed in an access target physical partition that is uniquely mapped with the access target logical partition, from among the plurality of physical partitions.

According to at least one example embodiment of the inventive concepts, the method further includes receiving the partition clearance signal; and setting an overall memory area of the nonvolatile semiconductor memory to be dynamically accessed according to the received partition clearance signal.

At least some example embodiments of the inventive concepts provide a storage device including a nonvolatile semiconductor memory including a memory area, the memory area including a plurality of different physical areas; and a memory controller configured to generate partition mapping information describing a manner in which a plurality of logical partitions are mapped to a plurality of physical partitions, the memory controller being configured to generate the partition mapping information based on a partition generation signal, the plurality of logical partitions being uniquely mapped to the plurality of physical partitions, respectively, the plurality of physical partitions corresponding to the plurality of different physical areas, respectively, the storage device being configured such that, after generation of the partition generation signal and before generation of a partition clearance signal, the memory controller controls the nonvolatile semiconductor memory to store received user data to be stored in a first logical address only in a first physical partition to which a first logical partition is mapped according to the partition mapping information, the first physical partition being a physical partition included in the plurality of physical partitions, the first logical partition being a logical partition in which the first logical address is included from among the plurality of logical partitions, and after generation of the partition clearance signal, the memory controller controls the nonvolatile semiconductor memory to store received user data to be stored in the first logical address in a selected one of the plurality of physical partitions, the selected physical partition being chosen by the memory controller regardless of the partition mapping information.

According to at least one example embodiment of the inventive concepts, the memory controller is configured to us a memory allocation algorithm which does not allocate memory based on the partition mapping information to choose the selected physical partition.

According to at least one example embodiment of the inventive concepts, the memory controller is configured to receive a partition generation command and a partition clearance command from a host, and the memory controller is configured to internally generate the partition generation signal and the partition clearance based on the partition generation command and the partition clearance command, respectively.

The storage device may be configured such that, after generation of the partition generation signal and before generation of the partition clearance signal, the first physical partition is not mapped with a second logical partition other than the first logical partition, the second logical partition being a logical partition included in the plurality of logical partitions.

The storage device may be configured such that, after generation of the partition generation signal and before generation of the partition clearance signal, the first logical partition is not mapped to a second physical partition other than the first physical partition, the second physical partition being a physical partition included in the plurality of physical partitions.

When a storage device implemented according to at least one example embodiment of the inventive concepts is used, integrity of data stored in each of a plurality of physical partitions may be improved, and security of data stored in each of the plurality of physical partitions may be improved. Further, storage may be utilized flexibly as necessary, by variously setting a memory use characteristic of each of the plurality of physical partitions.

### BRIEF DESCRIPTION OF THE FIGURES

The above and other features and advantages of example embodiments of the inventive concepts will become more apparent by describing in detail example embodiments of the inventive concepts with reference to the attached drawings. The accompanying drawings are intended to depict example embodiments of the inventive concepts and should not be interpreted to limit the intended scope of the claims. The accompanying drawings are not to be considered as drawn to scale unless explicitly noted.

FIG. 1 is a block diagram schematically illustrating a memory system according to at least one example embodiment of the inventive concepts;

FIG. 2 is a conceptual diagram for describing a general operation of a storage device;

FIGS. 3 and 4 are conceptual diagrams for describing an operation of a storage device according to at least one example embodiment of the inventive concepts;

FIG. 5 is a conceptual diagram for describing contents of mapping information according to at least one example embodiment of the inventive concepts;

FIGS. 6 and 7 are conceptual diagrams for describing contents of a partition generation signal according to at least one example embodiment of the inventive concepts;

FIGS. 8 and 9 are conceptual diagrams for describing an operation of a storage device according to at least one example embodiment of the inventive concepts;

FIGS. 10 to 12 are flow charts for describing a management method of a storage device according to at least one example embodiment of the inventive concepts;

FIG. 13 is a block diagram illustrating a single-host storage system according to at least one example embodiment of the inventive concepts;

FIG. 14 is a block diagram illustrating a memory card system according to at least one example embodiment of the inventive concepts;

FIG. 15 is a block diagram schematically illustrating a computing system including a storage or a memory card according to at least one example embodiment of the inventive concepts; and

FIG. 16 is a block diagram schematically illustrating a multi-host storage system according to at least one example embodiment of the inventive concepts.

### DETAILED DESCRIPTION

Detailed example embodiments of the inventive concepts are disclosed herein. However, specific structural and functional details disclosed herein are merely representative for purposes of describing example embodiments of the inventive concepts. Example embodiments of the inventive concepts may, however, be embodied in many alternate forms and should not be construed as limited to only the embodiments set forth herein.

Accordingly, while example embodiments of the inventive concepts are capable of various modifications and alternative forms, embodiments thereof are shown by way of example in the drawings and will herein be described in detail. It should be understood, however, that there is no intent to limit example embodiments of the inventive concepts to the particular forms disclosed, but to the contrary, example embodiments of the inventive concepts are to cover all modifications, equivalents, and alternatives falling within the scope of example embodiments of the inventive concepts. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the inventive concepts. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the inventive concepts. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

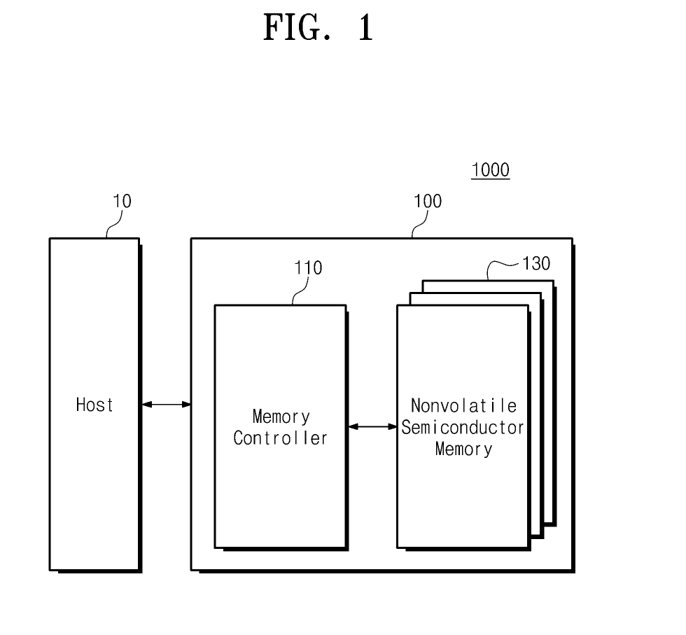

FIG. 1 is a block diagram schematically illustrating a memory system 1000 according to at least one example embodiment of the inventive concepts. A memory system 1000 includes a host 10 and a storage device 100. The storage device 100 includes a memory controller 110 and a nonvolatile semiconductor memory 130.

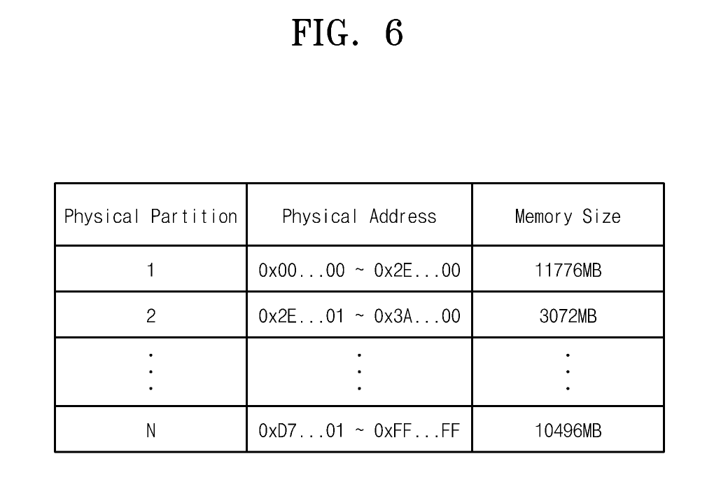

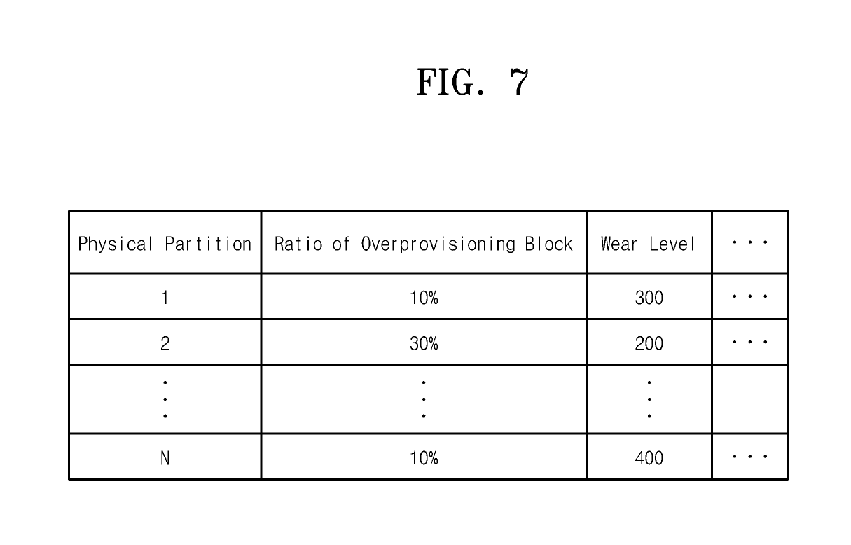

First, a partition generation signal may be generated in the memory system 1000. In at least some example embodiments of the inventive concepts, the partition generation signal may be generated based on a partition generation command provided from the host 10. When a user of the host 10 enters the partition generation command in the memory system 1000, the memory controller 110 receives the partition generation signal. In at least some example embodiments of the inventive concepts, a user of the host 10 may enter the partition generation command through a user interface. The entered partition generation command may be provided to the storage device 100 through a driver installed on the host 10. However, at least some example embodiments of the inventive concepts are not limited thereto, and the partition generation signal may be generated by other processes. For example, the storage device 100 may internally generate the partition generation signal when a desired condition is satisfied. The partition generation signal will be more fully described with reference to FIGS. 6 and 7.

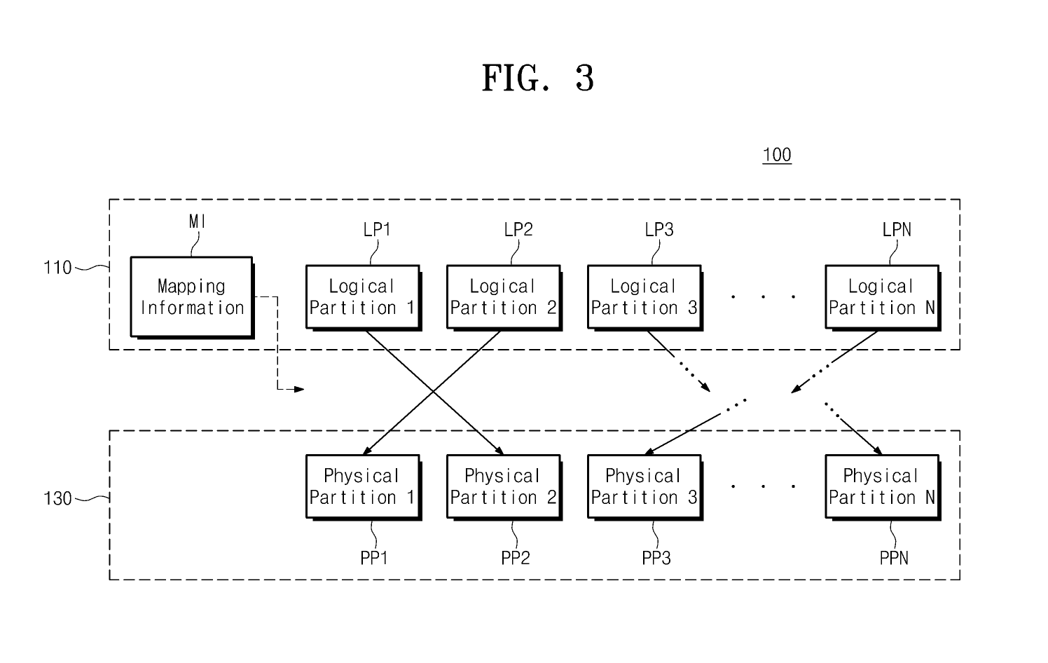

The memory controller 110 generates mapping information based on the partition generation signal. The mapping information is information with regard to a mapping relationship between a plurality of physical partitions respectively allocated to different physical areas of the nonvolatile semiconductor memory 130 and a plurality of logical partitions respectively mapped with the plurality of physical partitions. According to at least one example embodiment, the generated mapping information may be stored in a storage area of the memory controller 110. However, at least some example embodiments of the inventive concepts are not limited thereto. For example, the generated mapping information may be stored in a memory area included in the nonvolatile semiconductor memory 130 or in a separate storage area. The mapping information will be more fully described with reference to FIGS. 3 to 5.

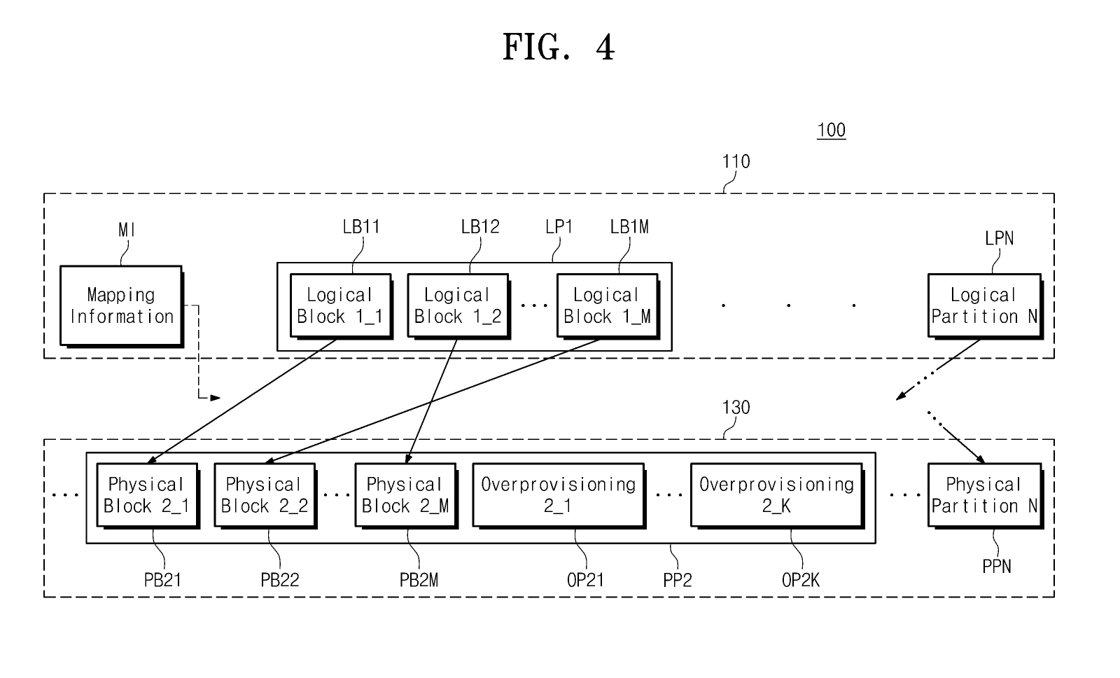

The nonvolatile semiconductor memory 130 may include a memory area for storing data. When the mapping information is generated, the memory area of the nonvolatile semiconductor memory 130 is divided into a plurality of physical partitions based on the mapping information. In particular, with at least one example embodiment of the inventive concepts, a plurality of logical partitions respectively mapped with a plurality of physical partitions may be uniquely determined until a partition clearance signal is provided. For example, if a first logical partition is mapped with a first physical partition, a second logical partition cannot be mapped with the first physical partition. Also, if the first logical partition is mapped with the first physical partition, the first logical partition cannot be mapped with a second physical partition. The first logical partition and the first physical partition, mapped with each other, have a unique mapping relationship until the partition clearance signal is provided. Accordingly, the logical partitions and the physical partitions may have a unique, one-to-one mapping relationship with each other. The mapping relationship between the plurality of logical partitions and the plurality of physical partitions will be more fully described with reference to FIGS. 3 and 4.

The partition clearance signal may be generated in the memory system 1000. According to at least one example embodiment, the partition clearance signal may be generated based on a partition clearance command provided from the host 10. That is, when a user of the host 10 enters the partition clearance command in the memory system 1000, the memory controller 110 may receive the partition clearance signal. In at least some example embodiments of the inventive concepts, a user of the host 10 may enter the partition clearance command through a user interface. The entered partition clearance command may be provided to the storage device 100 through a driver installed on the host 10. However, at least some example embodiments of the inventive concepts are not limited thereto, and the partition clearance signal may be generated by other processes. For example, the storage device 100 may internally generate the partition clearance signal when a desired condition is satisfied.

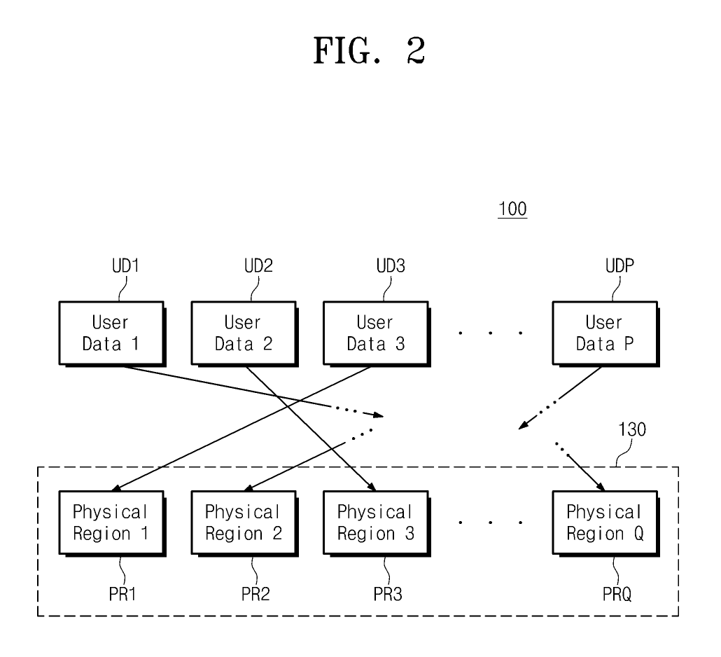

After the partition clearance signal is provided, the memory area of the nonvolatile semiconductor memory 130 is not divided into the plurality of physical partitions. That is, the memory controller 110 controls the nonvolatile semiconductor memory 130 in response to the partition clearance signal such that all memory areas of the nonvolatile semiconductor memory 130 are set to be dynamically accessed. The nonvolatile semiconductor memory 130 including memory areas dynamically accessed will be more fully described with reference to FIG. 2.

FIG. 2 is a conceptual diagram for describing a general operation of a storage device 100. A memory area included in a nonvolatile semiconductor memory 130 may be formed of Q physical regions PR1 to PRQ which are divided by a page unit (alternatively, a block unit). In general, Q physical regions PR1 to PRQ may be accessed dynamically. That is, the Q physical regions PR1 to PRQ may be accessed according to a sequence calculated by a desired algorithm, regardless of a physical arrangement order of the Q physical regions PR1 to PRQ. For example, the memory controller 110 may control the nonvolatile semiconductor memory device 130 to store user data to be stored at a first logical address, which corresponds to a first logical partition, in a physical area chosen by the desired algorithm, regardless the mapping of the first logical partition. For example, the desired algorithm may choose the chosen physical area of the nonvolatile semiconductor memory 130 regardless of whether or not the first logical partition is mapped to the physical partition corresponding to the chosen physical area in the mapping information of the plurality of physical partitions and the plurality of logical partitions generated by the memory controller 110.

As an example, when P user data UD1 to UDP are provided, as illustrated in FIG. 2, where P is a positive integer, second user data UD2 may be stored in a third physical region PR3 and third user data UD3 may be stored in a first physical region PR1. However, even if the same P user data UD1 to UDP are provided again, unlike FIG. 2, the second user data UD2 may be stored in the first physical region PR1, and the physical region PR3 may store first user data UD1. The Q regions may be accessed in the manner described above with reference to FIG. 2 because the Q physical regions PR1 to PRQ are configured to be dynamically accessed in general.

A typical storage device 100 operates as described above. Also, the storage device 100 that is provided with the partition clearance signal according to at least one example embodiment of the inventive concepts operates as described above. Below, there will be described an operation of the storage device 100 that operates based on mapping information generated according to a partition generation signal.

FIG. 3 is a conceptual diagram for describing an operation of a storage device 100 according to at least one example embodiment of the inventive concepts. When a partition generation signal is provided, mapping information MI is generated. In FIG. 3, there is illustrated an embodiment in which the mapping information MI is stored in a storage area included in a memory controller 110. However, as described with reference to FIG. 1, at least some example embodiments of the inventive concepts are not limited thereto.

When the partition generation signal is provided or the mapping information MI is generated, information with respect to N logical partitions LP1 to LPN is generated. A memory area included in a nonvolatile semiconductor memory 130 may be divided into N physical partitions PP1 to PPN based on the mapping information MI. The N physical partitions PP1 to PPN are allocated to different physical areas, respectively. The N logical partitions LP1 to LPN are mapped with the N physical partitions PP1 to PPN, respectively. The mapping information MI may include information with respect to a mapping relationship between the N physical partitions PP1 to PPN and the N logical partitions LP1 to LPN.

In particular, in a storage device 100 according to at least some example embodiments of the inventive concepts, the manner in which the N logical partitions LP1 to LPN are respectively mapped to the N physical partitions PP1 to PPN is uniquely determined. As an example, if a first logical partition LP1 is mapped with a second physical partition PP2, a second logical partition LP2 cannot be mapped with the second physical partition PP2. Also, if the first logical partition LP1 is mapped with the second physical partition PP2, the first logical partition LP1 cannot be mapped with a physical partition other than the second physical partition PP2. The first logical partition LP1 and the second physical partition PP2, mapped with each other, have a unique mapping relationship until a partition clearance signal is provided. That is, the first logical partition LP1 is not mapped with a physical partition other than the second physical partition PP2 until the partition clearance signal is provided.

However, a mapping relationship shown in FIG. 3 is only an example, and at least some example embodiments of the inventive concepts are not limited thereto. For example, the first logical partition LP1 may be mapped with the first physical partition PP1 based on the mapping information. If the first logical partition LP1 is mapped with the first physical partition PP1, the first logical partition LP1 cannot be mapped with a physical partition other than the first physical partition PP1 until the partition clearance signal is provided. That is, the manner in which N physical partitions PP1 to PPN are respectively mapped to the N logical partitions LP1 to LPN may be different from that described with reference to FIG. 3. According to at least some example embodiments, the associated physical and logical partitions have a unique mapping relationship until the partition clearance signal is provided. After the partition clearance signal is provided and then a partition generation signal is provided again, the manner in which the N physical partitions PP1 to PPN are mapped to the N logical partitions LP1 to LPN may be different from that described with reference to FIG. 3.

FIG. 4 is a conceptual diagram for describing an operation of a storage device 100 according to at least one example embodiment of the inventive concepts. In FIG. 4, a second physical partition PP2 and a first logical partition LP1 are illustrated in detail.

The second physical partition PP2 may include M physical blocks PB21 to PB2M, where M is a positive integer. The second physical partition PP2 may further include K overprovisioning blocks OP21 to OP2K, where K is a positive integer. The first logical partition LP1 may include M logical blocks LB11 to LB1M.

According to at least one example embodiment of the inventive concepts, because the second physical partition PP2 and the first logical partition LP1 have a unique mapping relationship, the M logical blocks LB11 to LB1M are mapped with the M physical blocks PB21 to PB2M, respectively. According to at least one example embodiment of the inventive concepts, the M logical blocks LB11 to LB1M and the M physical blocks PB21 to PB2M have a unique mapping relationship. However, alternatively, the M logical blocks LB11 to LB1M and the M physical blocks PB21 to PB2M may have a dynamic mapping relationship. That is, after being mapped with the first physical block PB21, the first logical block LB11 may be mapped with the second physical block PB22.

As described above, N physical partitions PP1 to PPN and N logical partitions LP1 to LPN have a unique mapping relationship. However, a mapping relationship between the M physical blocks PB21 to PB2M included in one of the N physical partitions PP1 to PPN and the M logical blocks LB11 to LB1M included in one of the N logical partitions LP1 to LPN may be unique or dynamic.

The K overprovisioning blocks OP21 to OP2K (K being a positive integer) may be used, for example, as a buffer. The K overprovisioning blocks OP21 to OP2K may temporarily store data to be stored in the M physical blocks PB21 to PB2M. A physical location of a block performing an overprovisioning function may not be fixed. For example, the first physical block PB21 may be replaced with an overprovisioning block, and the first overprovisioning block OP21 may be replaced with a physical block. In each of the N physical partitions PP1 to PPN, a ratio of the overprovisioning blocks to the physical blocks may be changed or modified. Also, each of the physical partitions PP1 to PPN may have different values of ratios of the overprovisioning blocks to the physical blocks.

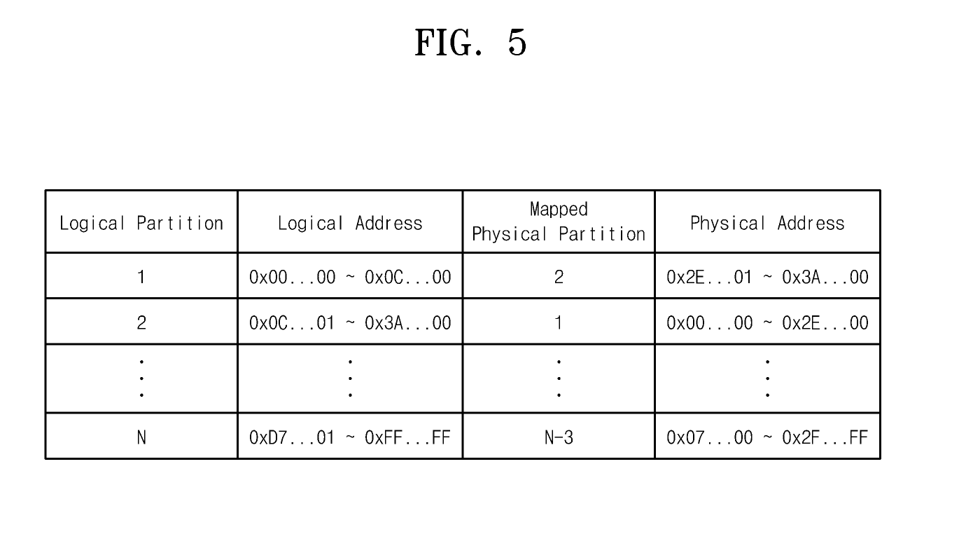

FIG. 5 is a conceptual diagram for describing contents of mapping information according to at least one example embodiment of the inventive concepts. For example, according to at least one example embodiment of the inventive concepts, mapping information is generated when a partition generation signal is provided to a storage device 100, which is illustrated in FIG. 1.

The mapping information may include information corresponding to an address range of each of a plurality of logical partitions. The mapping information may include information corresponding to an address range of each of a plurality of physical partitions. The mapping information may include information identifying the plurality of physical partitions with which the plurality of logical partitions are respectively mapped. That is, the mapping information may be information describing a mapping relationship between a plurality of physical partitions respectively allocated to different physical areas of the nonvolatile semiconductor memory 130 and a plurality of logical partitions respectively mapped to the plurality of physical partitions.

The storage device 100 may divide a memory area included in the nonvolatile semiconductor memory 130 into the plurality of physical partitions based on the mapping information. Until a partition clearance signal is provided, the plurality of logical partitions is uniquely and respectively mapped with the plurality of physical partitions based on the mapping information. The mapping relationship shown in FIG. 5 is provided as an example of the manner in which logical and physical partitions may be mapped to each other in memory area of the nonvolatile semiconductor memory 130. The plurality of physical partitions and the plurality of logical partitions may have a mapping relationship different from that described with reference to FIG. 5. According to at least one example embodiment of the inventive concepts, a unique mapping relationship between associated physical and logical partitions is kept until the partition clearance signal is provided. Mapping information shown in FIG. 5 is provided as an example and may further include contents other than contents described with reference to FIG. 5.

FIG. 6 is a conceptual diagram for describing contents of a partition generation signal according to at least one example embodiment of the inventive concepts.

A partition generation signal may include information corresponding to a physical address range of each of physical areas to which a plurality of physical partitions are respectively allocated. The partition generation signal may include information corresponding to a memory size of each of the plurality of physical partitions. That is, the partition generation signal may include information from which mapping information can be generated. FIG. 6 shows an embodiment for providing a better understanding of the partition generation signal according to at least some example embodiments of the inventive concepts. The partition generation signal may further include other contents other than contents shown in FIG. 6. Alternatively, the partition generation signal may include either information identifying a physical address range or information identifying a memory size.

As described with reference to FIG. 1, according to at least one example embodiment of the inventive concepts, the partition generation signal may be generated based on a partition generation command provided from the host 10. According to at least one example embodiment of the inventive concepts, the partition generation command may have a parameter for setting one or more physical address ranges of physical areas to which a plurality of physical partitions are respectively allocated. Also, the partition generation command may have one or more parameters for setting memory sizes of each of the plurality of physical partitions.

In at least some example embodiments of the inventive concepts, a user of the host 10 may set a parameter value directly while entering the partition generation command in a memory system 1000 through a user interface. For example, the user of the host 10 may enter the partition generation command with a parameter for dividing a memory area of the nonvolatile semiconductor memory 130 having 25-MB memory capacity into three partitions that have 12-MB, 8-MB, and 5-MB memory capacity, respectively. However, at least some example embodiments of the inventive concepts may be implemented according to arrangements other than those described above.

FIG. 7 is a conceptual diagram for describing contents of a partition generation signal according to at least one example embodiment of the inventive concepts.

A partition generation signal may include information describing a memory use characteristic of each of a plurality of physical partitions. The memory use characteristic is a characteristic for setting a use environment of a memory area of each physical partition. For example, the memory use characteristic may include a ratio of blocks that perform an overprovisioning function, from among physical blocks included in each physical partition. Also, the memory use characteristic may include a wear level of physical blocks included in each physical partition. The memory use characteristic shown in FIG. 7 is an example for providing a better understanding of at least some example embodiments of the inventive concepts. The memory use characteristic may further include other contents other than contents shown in FIG. 7. Alternatively, the memory use characteristic may include either the ratio of blocks with the overprovisioning function or the wear level.

As described with reference to FIG. 1, according to at least one example embodiment, the partition generation signal may be generated based on a partition generation command from the host 10. According to at least one example embodiment, the partition generation command may have a parameter for setting a memory use characteristic. For example, the partition generation command may have a parameter for setting a ratio of blocks that perform an overprovisioning function, from among physical blocks included in each physical partition. Also, the partition generation command may have a parameter for setting a wear level with respect to each physical partition.

In at least some example embodiments of the inventive concepts, a user of the host 10 may set a value of a parameter directly while entering the partition generation command in a memory system 1000 through a user interface. Further, a value of a memory use characteristic of at least one of a plurality of physical partitions may be set to be different from that of another physical partition. That is, all physical partitions need not to have the same memory use characteristics.

For example, the number of overprovisioning blocks in a first physical partition may be different than the number of overprovisioning blocks in a second physical partition. Alternatively, the number of overprovisioning blocks in the first physical partition may be same as that in the second physical partition. Accordingly, the user of the host 10 may utilize the storage device 100 flexibly as necessary, by properly setting a memory use characteristic of each physical partition. At least some example embodiments of the inventive concepts may be implemented using arrangements different than those described above.

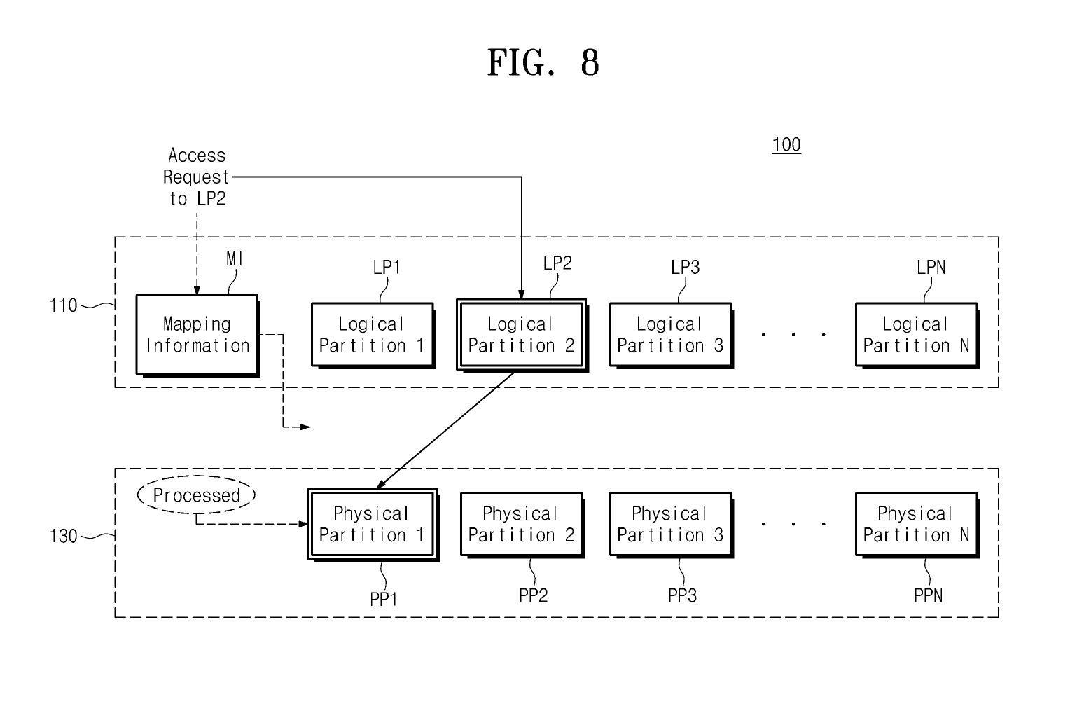

FIG. 8 is a conceptual diagram for describing an operation of a storage device 100 according to at least one example embodiment of the inventive concepts. In FIG. 8, illustrates a procedure of processing an access request according to at least one example embodiment of the inventive concepts. For better understanding, it is assumed that a second logical partition LP2 is mapped with a first physical partition PP1 based on mapping information MI.

In the example illustrated in FIG. 8, first, an access request with respect to one or more logical partitions is provided from the host 10 to the storage device 100. The access request may be, for example, a data read request, a data write request, and so on. A memory controller 110 may determine an access target physical partition that is to be uniquely mapped with an access target logical partition based on mapping information MI. The memory controller 110 controls a nonvolatile semiconductor memory 130 such that the access request is processed in the access target physical partition.

For example, it is assumed that a data write request for the second logical partition LP2 is provided. In this example, an access target logical partition is the second logical partition LP2. An access target physical partition to be uniquely mapped with an access target logical partition is determined based on the mapping information MI. In this example, the access target physical partition is the first physical partition PP1. The memory controller 110 controls the nonvolatile semiconductor memory 130 such that a data write operation is processed in the first physical partition PP1.

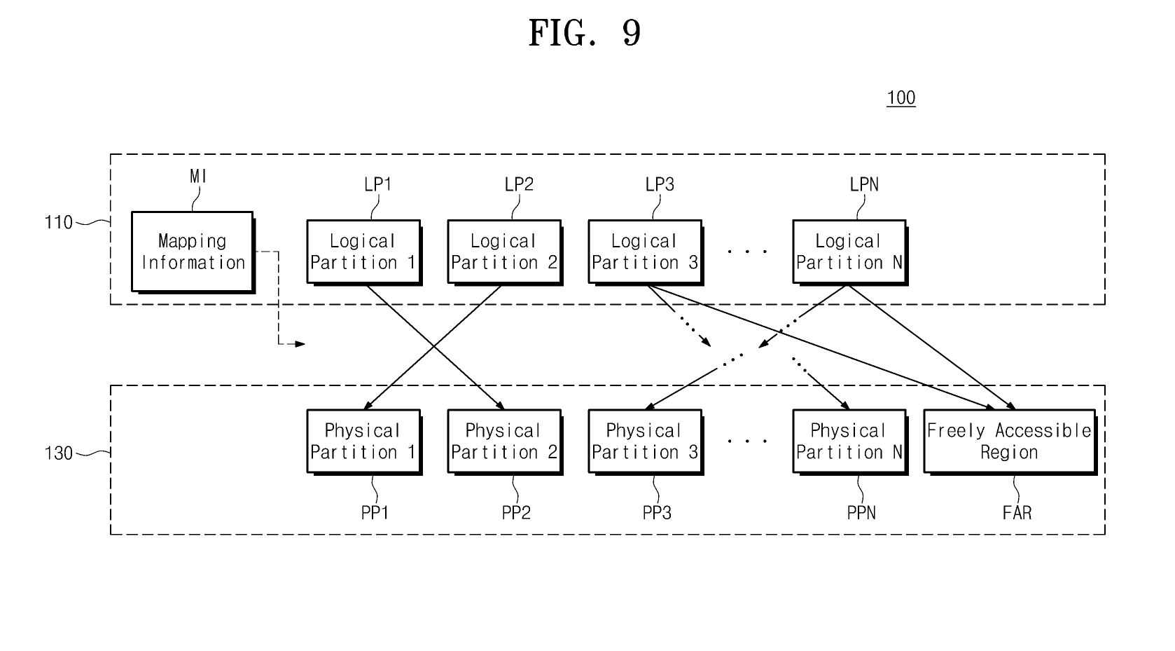

FIG. 9 is a conceptual diagram for describing an operation of a storage device 100 according to at least one example embodiment of the inventive concepts. According to at least one example embodiment, a memory area included in a nonvolatile semiconductor memory 130 may further include a freely accessible region FAR.

The freely accessible region FAR may be a memory area that is mapped in common with two or more of a plurality of logical partitions LP1 to LPN. Alternatively, the freely accessible region FAR may be a memory area that is accessed regardless of mapping information MI. That is, the freely accessible region FAR may be an area that is accessed without being influenced by a unique mapping relationship between a plurality of physical partitions PP1 to PPN and the plurality of logical partitions LP1 to LPN.

As an example, the freely accessible region FAR may be a memory area that is mapped in common with a third logical partition LP3 and an N-th logical partition LPN. However, at least some example embodiments of the inventive concepts are not limited thereto. In some cases, location and the number of logical partitions mapped with the freely accessible region FAR may be changed. As an example, the freely accessible region FAR may be a memory area that is mapped in common with all the logical partitions LP1 to LPN. That is, the freely accessible region FAR may be a memory area that is accessed regardless of the mapping information MI. As an example, data with respect to a resource that is globally used in a storage device 100 may be stored in the freely accessible region FAR.

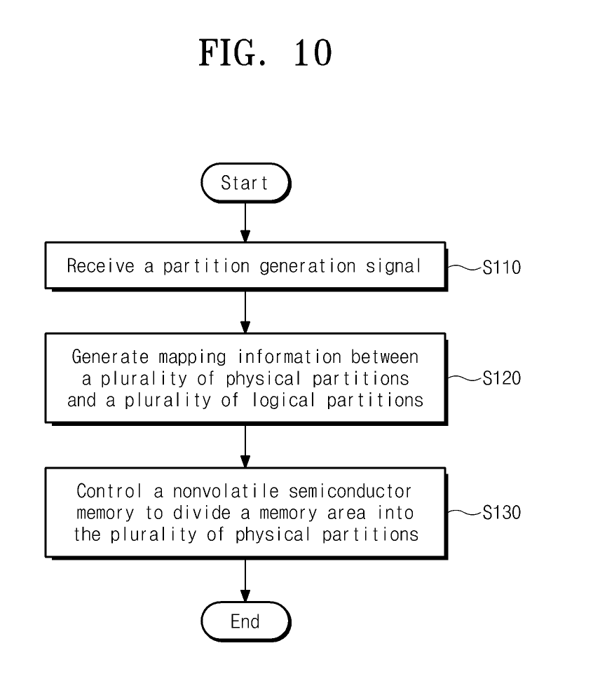

FIG. 10 is a flow chart for describing a management method of a storage device according to at least one example embodiment of the inventive concepts.

In step S110, a partition generation signal is received. For example, the partition generation signal may be generated based on a partition generation command. When a user of a host enters the partition generation command, the partition generation signal may be provided, for example by the host 110, and received, for example by the storage device 100. In at least some example embodiments of the inventive concepts, the user of the host may enter the partition generation command through a user interface. However, at least some example embodiments of the inventive concepts are not limited thereto. The partition generation signal may be generated according to a procedure different from the above-described procedure. The partition generation signal is described in detail with reference to FIGS. 6 and 7.

In step S120, mapping information is generated. The mapping information may be generated, for example by the memory controller 110, based on the partition generation signal provided in step S110. As described above, the mapping information may be information describing a mapping relationship between a plurality of physical partitions respectively allocated to different physical areas of a nonvolatile semiconductor memory 130 and a plurality of logical partitions respectively mapped with the plurality of physical partitions. The mapping information is described in detail with reference to FIGS. 3 to 5.

In step S130, a memory area is divided into the plurality of physical partitions, for example by memory controller 110 controlling the nonvolatile semiconductor memory 130. The nonvolatile semiconductor memory may be controlled based on the mapping information generated in step S120. In particular, with at least one example embodiment of the inventive concepts, the plurality of logical partitions respectively mapped with the plurality of physical partitions may be uniquely determined until a partition clearance signal is received at the storage device 100.

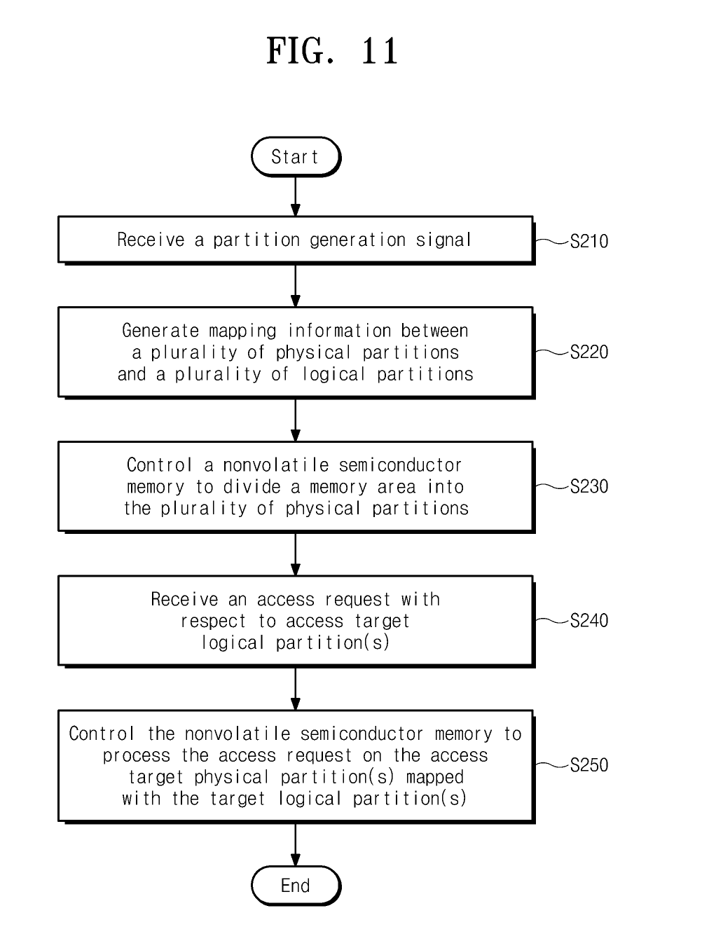

FIG. 11 is a flow chart for describing a management method of a storage device according to at least one example embodiment of the inventive concepts. In particular, FIG. 11 illustrates a procedure of processing an access request according to at least one example embodiment of the inventive concepts. In FIG. 11, steps S210, S220, and S230 may be the same as steps S110, S120, and S130 shown in FIG. 10, and a description thereof is thus omitted.

In step S240, an access request for one or more logical partitions is provided from a host and received at the storage device 100. A logical partition being a target of the access request may be referred to as an access target logical partition. Here, the access request may be, for example, a data read request, a data write request, or another type of request.

In step S250, a nonvolatile semiconductor memory 130 is controlled, for example by the memory controller 110, such that the access request is processed in an access target physical partition. The access target physical partition may be a physical partition that is uniquely mapped with the access target logical partition, from among a plurality of physical partitions. The access target physical partition may be determined, for example by the memory controller 110, based on mapping information generated in step S220. An operation of processing the access request is described with reference to FIG. 8.

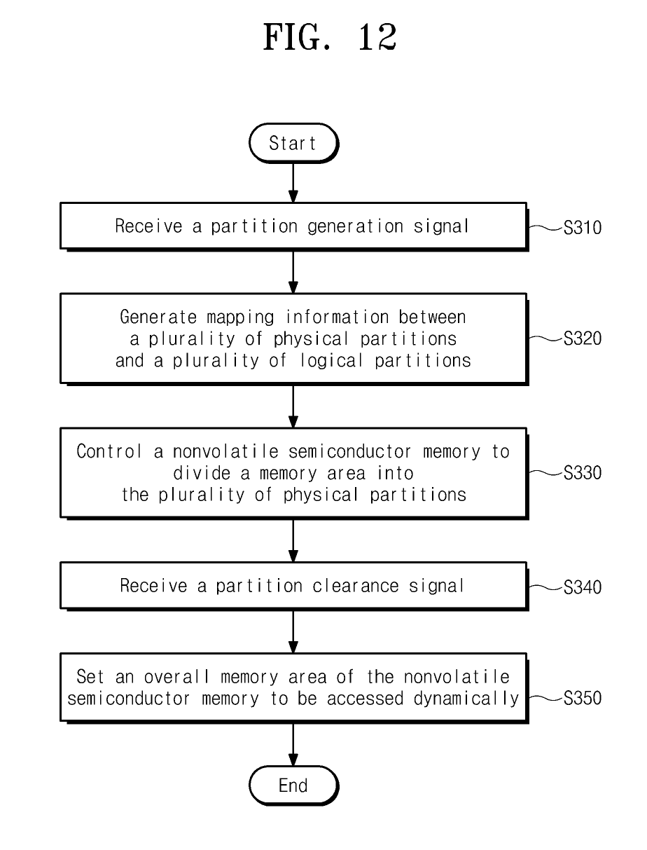

FIG. 12 is a flow chart for describing a management method of a storage device according to still at least one example embodiment of the inventive concepts. In particular, FIG. 12 illustrates a procedure of clearing a partition configuration. In FIG. 12, steps S310, S320, and S330 are the same as steps S110, S120, and S130 shown in FIG. 10, and a description thereof is thus omitted.

In step S340, a partition clearance signal is provided, for example by the host 10, and received at the storage device 100. The partition clearance signal may be produced based on a partition clearance command provided from a host. The partition clearance signal may be provided and received when a user of the host enters the partition clearance command. In at least some example embodiments of the inventive concepts, the user of the host may enter the partition clearance command through a user interface. However, at least some example embodiments of the inventive concepts are not limited thereto. The partition clearance signal may be generated through a procedure different from that described above.

In step S350, an overall memory area of the nonvolatile semiconductor memory is set to be accessed dynamically. In particular, step S350 is executed in response to the partition clearance signal provided in step S340. According to the execution of step S350, a memory area of the nonvolatile semiconductor memory is not divided into a plurality of physical partitions. A manner in which an overall memory area of the nonvolatile semiconductor memory 130 is accessed dynamically is described in detail above with reference to FIG. 2.

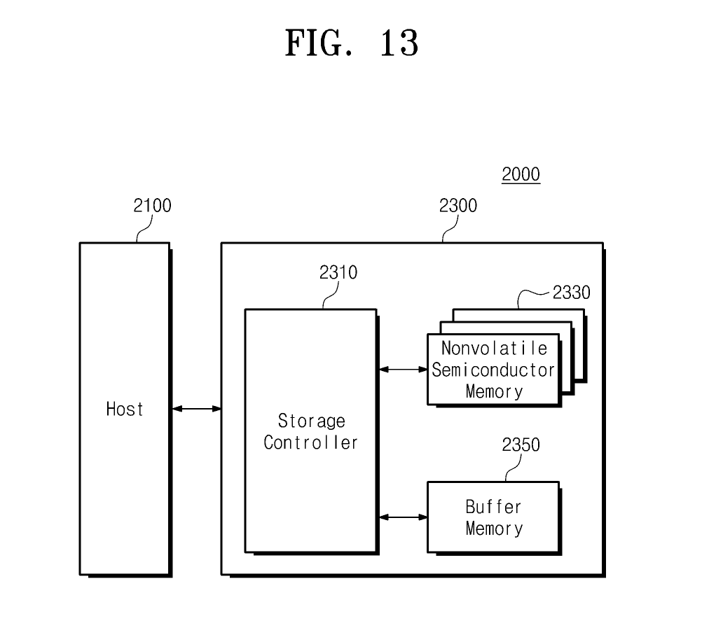

FIG. 13 is a block diagram illustrating a single host storage system 2000 according to at least one example embodiment of the inventive concepts. Referring to FIG. 13, a single host storage system 2000 includes a host 2100 and storage 2300. The storage 2300 may include a storage controller 2310, a nonvolatile semiconductor memory 2330, and a buffer memory 2350. In at least some example embodiments of the inventive concepts, the storage 2300 may be a solid state drive. However, at least some example embodiments of the inventive concepts are not limited thereto.

The storage controller 2310 may provide physical interconnection between the host 2100 and the storage 2300. The storage controller 2310 may process the interface protocol corresponding to a bus format of the host 2100. The storage controller 2310 provides an interface between the host 2100 and the storage 2300. The bus format of the host 2100 may include, for example, USB (Universal Serial Bus), SCSI (Small Computer System Interface), PCIe (Peripheral Component Interconnect express), ATA (Advanced Technology Attachment), PATA (Parallel ATA), SATA (Serial ATA), SAS (Serial Attached SCSI), IDE (Integrated Drive Electronics), and the like.

The storage controller 2310 decodes a command provided from the host 2100. In particular, the storage controller 2310 decodes a partition generation command and a partition clearance command. The storage controller 2310 controls the nonvolatile memory device 2330 according to the decoded result.

The nonvolatile memory device 2330 may include one or more memory areas. In this case, each memory area may be connected with the storage controller 2310 by a unit of the channel. In at least some example embodiments of the inventive concepts, when the storage 2300 is a SSD, the nonvolatile memory device 2330 is formed of, for example, a NAND flash memory. However, the nonvolatile memory device 2330 is not limited to a NAND flash memory device. For example, the nonvolatile semiconductor memory 2330 may be formed of one or more of a PRAM (Phase-change RAM), an MRAM (Magneto-resistive RAM), a ReRAM (Resistive RAM), an FRAM (Ferro-electric RAM), a NOR flash memory, and the like. According to at least some example embodiments of the inventive concepts, different types of memory devices may be used together.

The storage controller 2310 and the nonvolatile semiconductor memory 2330 are implemented to operate according to at least one example embodiment of the inventive concepts. That is, if the partition generation command is provided from the host 2100, the storage controller 2310 generates mapping information between a plurality of physical partitions, respectively allocated to different physical areas of the nonvolatile semiconductor memory 2330, and a plurality of logical partitions, respectively mapped with the plurality of physical partitions. The memory area of the nonvolatile semiconductor memory 2330 is divided into a plurality of physical partitions based on the generated mapping information. The plurality of logical partitions respectively mapped with the plurality of physical partitions may be uniquely determined until a partition clearance command is provided from the host 2100.

According to at least one example embodiment of the inventive concepts, the host 2100, the nonvolatile semiconductor memory 2330 and the storage controller 2310 of the single host storage system 2000 may have the operations described with respect to the host 10, the nonvolatile semiconductor memory 100 and the memory controller 110 in the discussions of FIGS. 1-12 above. Further, the storage system 2000 may include a buffer memory 2350. The buffer memory 2350 temporarily stores write data provided from the host 2100 or data read out from the nonvolatile semiconductor memory 2330. According to at least some example embodiments of the inventive concepts, if data for the nonvolatile semiconductor memory 2330 is cached when the host 2100 provides a read request, the buffer memory 2350 may support a caching function for providing the cached data directly to the host 2100.

Typically, a data transfer speed of a bus format of the host 2100 may be faster than that of a memory channel of the storage 2300. The buffer memory 2350 may be used to compensate for a decrease in the performance due to a data transfer speed difference between the host 2100 and the storage 2300. The buffer memory 2350 may be implemented with, for example, a synchronous DRAM to provide a sufficient buffering. However, at least some example embodiments of the inventive concepts are not limited thereto.

When a storage device implemented according to at least one example embodiment of the inventive concepts is used in a single host storage system, integrity of data stored in each of a plurality of physical partitions of a nonvolatile semiconductor memory may be improved. This improvement is experienced because one physical partition is not shared by a plurality of logical partitions, and thus a probability that garbage data is read or stored is low. Further, storage may be utilized flexibly as necessary, by variously setting a memory use characteristic of each physical partition.

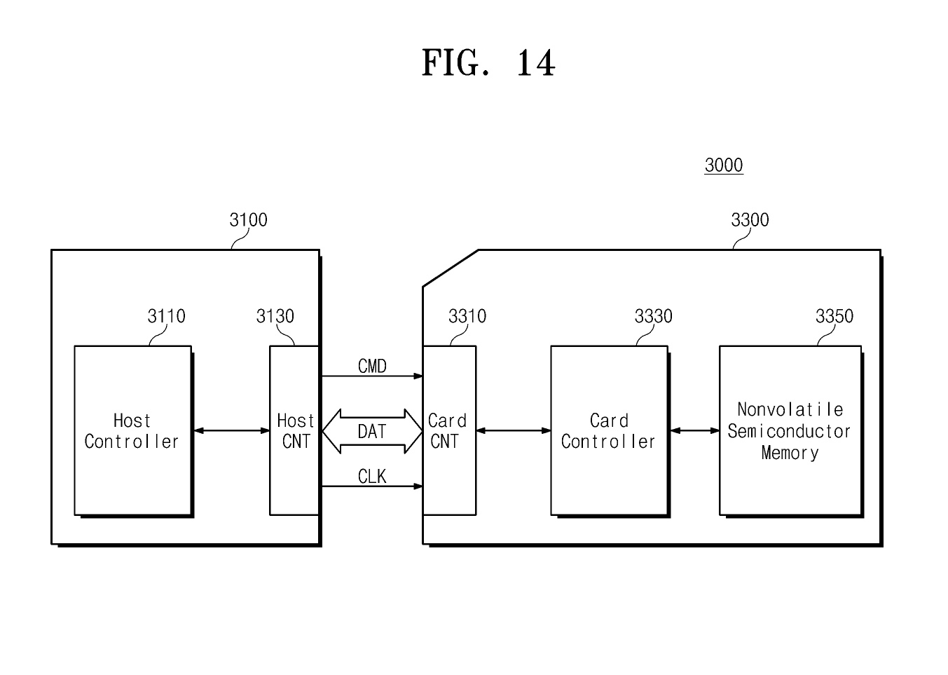

FIG. 14 is a block diagram illustrating a memory card system 3000 according to at least one example embodiment of the inventive concepts. Referring to FIG. 14, a memory card system 3000 includes a host 3100 and a memory card 3300. The host 3100 may include a host controller 3110 and a host connection unit 3130. The memory card 3300 may include a card connection unit 3310, a card controller 3330, and a nonvolatile semiconductor memory 3350. In at least some example embodiments of the inventive concepts, the memory card 3300 may be an eMMC (Embedded Multimedia Card). However, at least some example embodiments of the inventive concepts are not limited thereto.

Each of the host connection unit 3130 and the card connection unit 3310 may be formed of one or more pins. Such pins may include a command signal pin, a data signal pin, a clock signal pin, a power supply pin, etc. The number of pins may vary according to a type of the memory card 3300. The card connection unit 3310 may be configured to communicate with the host 3100 according to one of various interface protocols such as USB, SCSI, PCIe, ATA, PATA, SATA, SAS, IDE, MMC, ESDI (Enhanced Small Disk Interface), and the like.

The host 3100 is configured to write data in the memory card 3300 or to read data stored in the memory card 3300. The host controller 3110 sends a command signal CMD, a clock signal CLK generated within a clock generator (not shown) of the host 3100, and a data signal DAT to the memory card 3300 via the host connection unit 3130 to the memory card 3300.

The card controller 3330 operates according to a command received via the card connection unit 3310. In particular, in at least one example embodiment of the inventive concepts, the card controller 3330 controls the nonvolatile semiconductor memory 3350 based on a partition generation command and a partition clearance command provided from the host 3100. The nonvolatile semiconductor memory 3350 stores data provided from the host 3100. For example, if the host 3100 is a digital camera, the nonvolatile semiconductor memory 3350 may store image data.

The card controller 3330 and the nonvolatile semiconductor memory 3350 may be implemented to operate according to at least one example embodiment of the inventive concepts. That is, if the partition generation command is provided from the host 3100, the card controller 3330 may generate mapping information between a plurality of physical partitions, respectively allocated to different physical areas of the nonvolatile semiconductor memory 3350, and a plurality of logical partitions, respectively mapped with the plurality of physical partitions. The memory area of the nonvolatile semiconductor memory 3350 is divided, for example by the card controller 3330, into the plurality of physical partitions based on the generated mapping information. The plurality of logical partitions respectively mapped with the plurality of physical partitions is uniquely determined until a partition clearance command is provided from the host 3100.

According to at least one example embodiment of the inventive concepts, the host 3100 as well as the nonvolatile semiconductor memory 3350 and the card controller 3330 (of the memory card 3300) included in the memory card system 3000 may have the operations described with respect to the host 10, the nonvolatile semiconductor memory 100 and the memory controller 110 in the discussions of FIGS. 1-12 above.

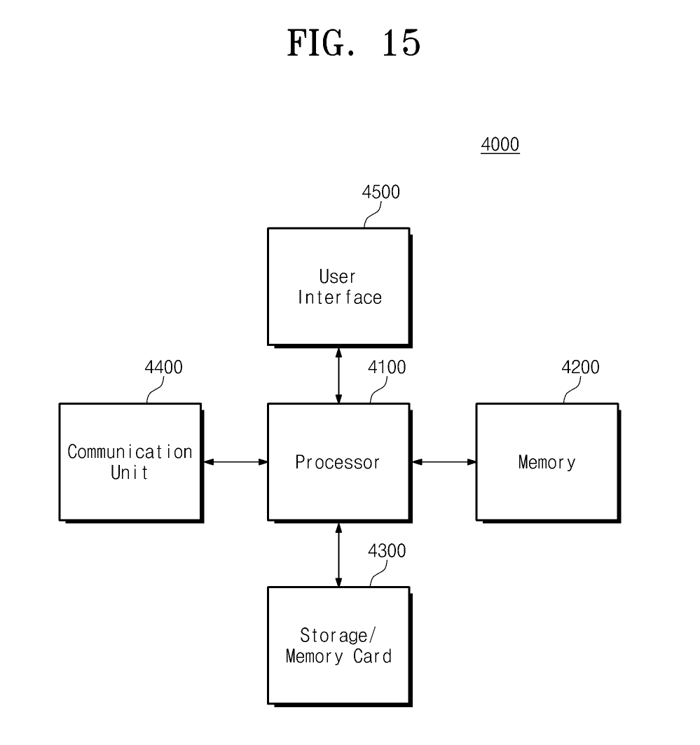

FIG. 15 is a block diagram schematically illustrating a computing system 4000 including storage or a memory card according to at least one example embodiment of the inventive concepts. A computing system 4000 includes a processor 4100, a memory 4200, a storage/memory card 4300, a communication unit 4400, and a user interface 4500.

The processor 4100 controls an operation of the computing system 4000. The processor 4100 may perform a variety of operations. For example, the processor 4100 may be formed of a system on chip (SoC). The processor 4100 may be a general-purpose processor, which is used in a general computer or workstation. Alternatively, the processor 4100 may be an application processor (AP), which is used in a mobile device, such as a handheld phone.

The memory 4200 exchanges data with the processor 4100. The memory 4200 may be a main memory of the processor 4100 or the computing system 4000. The memory 4200 may include a volatile memory including, for example, SRAM, DRAM, or SDRAM, or a nonvolatile semiconductor memory including, for example, flash memory, PRAM, MRAM, ReRAM, or FRAM. The memory 4200 may include one or more memory modules or one or more memory packages.

The storage/memory card 4300 may, for example, store data that is to be stored for a long time. The storage/memory card 4300 may be a flash memory device such as SSD or eMMC, or a device including a nonvolatile semiconductor memory such as PRAM, MRAM, ReRAM, or FRAM. The storage/memory card 4300 may be storage 2300 shown in FIG. 13 or a memory card 3300 shown in FIG. 14.

The storage/memory card 4300 may be implemented to operate according to at least one example embodiment of the inventive concepts. That is, if the partition generation command is provided, mapping information between a plurality of physical partitions, respectively allocated to different physical areas of the storage/memory card 4300, and a plurality of logical partitions, respectively mapped with the plurality of physical partitions, may be generated. The memory area of the storage/memory card 4300 is divided into a plurality of physical partitions based on the generated mapping information. The plurality of logical partitions respectively mapped with the plurality of physical partitions may be uniquely determined until a partition clearance command is provided.

The communication unit 4400 communicates with an external device of the computing system 4000 according to a control of the processor 4100. The communication unit 4400 communicates with the external device of the computing system 4000 according to the wired or wireless communication protocol. For example, the communication unit 4400 communicates with the external device of the computing system 4000 according to at least one of a variety of wireless communication protocols including, for example, LTE (Long Term Evolution), WiMax, GSM (Global System for Mobile communication), CDMA (Code Division Multiple Access), Bluetooth, NFC (Near Field Communication), WiFi, RFID (Radio Frequency Identification), and so on, or a variety of wired communication protocols such as USB, SCSI, PCIe, ATA, PATA, SATA, SAS, Firewire, and so on.

The user interface 4500 provides interfacing for communication between a user and the computing system 4000 according to a control of the processor 4100. For example, the user interface 4500 may include input interfaces including, for example, a keyboard, a button, a keypad, a touch screen, a touch panel, a touch pad, a touch ball, a camera, a microphone, a Gyroscope sensor, a vibration sensor, and the like. The user interface 4500 may further include output interfaces including, for example, an LCD (Liquid Crystal Display), an OLED (Organic Light Emitting Diode) display device, an AMOLED (Active Matrix OLED) display device, an LED, a speaker, a motor, and the like.

According to at least one example embodiment of the inventive concepts, the storage card/memory card 4300 may have the operations described with respect to the memory card 3300 in the discussions of FIGS. 1-12 and 14 above.

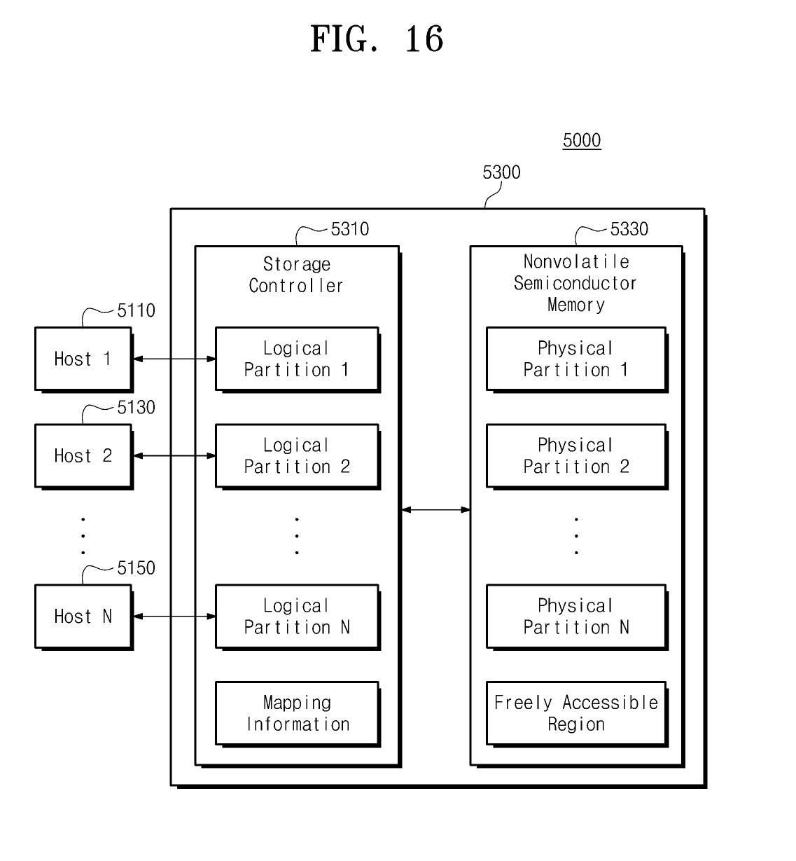

FIG. 16 is a block diagram schematically illustrating a multi-host storage system 5000 according to at least one example embodiment of the inventive concepts. A multi-host storage system 5000 includes a plurality of hosts 5110, 5130, 5150 and a storage 5300. Though N hosts 5110, 5130 and 5150 are shown in FIG. 16, the multi-host system 5000 may include only two hosts or more than three hosts. Accordingly, the multi-host system 5000 may include two or more hosts. The storage 5300 includes a storage controller 5310 and a nonvolatile semiconductor memory 5330. A configuration and a function of each component of a single host storage system 2000 described above with reference to FIG. 13 may be included in a configuration and a function of each component of the multi-host storage system 5000, respectively. Thus, a duplicated description of FIG. 13 is omitted in the description of FIG. 16.

With at least one example embodiment of the inventive concepts, the nonvolatile semiconductor memory 5330 is divided into a plurality of physical partitions based on mapping information. A plurality of logical partitions respectively mapped with the plurality of physical partitions may be uniquely determined based on the mapping information. Further, each of the plurality of hosts 5110, 5130, 5150 may have an authority for accessing one or more logical partitions. In FIG. 16, there is illustrated an example in which one of the plurality of hosts 5110, 5130, 5150 is connected with one of the plurality of logical partitions. However, the number of logical partitions connected with a host may be changed variously, for example, in accordance with a preference of a user. FIG. 16 is an example for providing a better understanding of at least some example embodiments of the inventive concepts.

The plurality of logical partitions is uniquely mapped with the plurality of physical partitions, respectively. Thus, each of the plurality of hosts 5110, 5130, 5150 may access only a physical partition that is mapped with a connected logical partition. That is, each of the plurality of hosts 5110, 5130, 5150 cannot access a physical partition other than the physical partition mapped with the connected logical partition. In at least some example embodiments of the inventive concepts, although one storage 5300 is provided, it may be recognized as a plurality of storage units or devices by a user of each of the plurality of hosts 5110, 5130, 5150.

This embodiment may be implemented by an MPIO (Multipath Input/Output) technology. In this case, communications between the plurality of hosts 5110, 5130, 5150 and the storage 5300 may be performed via a plurality of physical paths. In contrast, this embodiment may be implemented by an Single-Root Input/Output Virtualization (SR-IOV) or Multi-Root Input/Output Virtualization (MR-IOV) technology. The multi-host storage system 5000 may be implemented, for example, in a local computing system including two or more hosts. Alternatively, the multi-host storage system 5000 may be implemented in a web environment having a server-client structure. Alternatively, the multi-host storage system 5000 may be implemented in a wireless communication environment including mobile devices.

When a storage device implemented according to at least one example embodiment of the inventive concepts is used in a multi-host storage system, integrity of data stored in each of a plurality of physical partitions of a nonvolatile semiconductor memory may be improved. This improvement may be achieved because a physical partition is not shared by a plurality of logical partitions, and thus a probability that garbage data is read or stored is low. Furthermore, security of data stored in each of the plurality of physical partitions is improved. This improvement may be achieved because a host cannot access a physical partition other a physical partition mapped with a connected logical partition.

A nonvolatile semiconductor memory and a memory controller according to at least some example embodiments of the inventive concepts may be packaged according to a variety of different packaging technologies. Examples of such packaging technologies may include, for example, PoP (Package on Package), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), and the like.

Device components illustrated in each block diagram are provided for providing a better understanding of at least some of the inventive concepts. However, according to at least some example embodiments, each block may be formed of smaller blocks according to functionality. Further, according to at least some example embodiments, a plurality of blocks may constitute a larger block according to functionality. That is, at least some example embodiments of the inventive concepts are not limited to components illustrated in each block diagram.

Example embodiments having thus been described, it will be obvious that the same may be varied in many ways. Such variations are not to be regarded as a departure from the intended spirit and scope of example embodiments of the inventive concepts, and all such modifications as would be obvious to one skilled in the art are intended to be included within the scope of the following claims. at least some example embodiments of the inventive concepts

What is claimed is:

1. A storage device comprising:
a memory controller configured to generate mapping information between a plurality of physical partitions and a plurality of logical partitions based on a partition generation signal, the plurality of physical partitions respectively allocated to different physical areas, the plurality of logical partitions respectively mapped with the plurality of physical partitions; and
a nonvolatile semiconductor memory including a memory area divided into the plurality of physical partitions based on the generated mapping information,
wherein the memory controller is configured such that the plurality of logical partitions respectively mapped with the plurality of physical partitions is uniquely determined by the memory controller based on the generated mapping information, until a partition clearance signal is provided.

2. The storage device of claim 1, wherein the storage device is configured such that,
in response to a first physical partition included in the plurality of physical partitions and a first logical partition included in the plurality of logical partitions being uniquely mapped based on the generated mapping information and a second physical partition included in the plurality of physical partitions and a second logical partition included in the plurality of logical partitions are uniquely mapped based on the generated mapping information, the first logical partition and the second logical partition are only mapped with the first physical partition and the second physical partition, respectively, until the partition clearance signal is provided.

3. The storage device of claim 1, wherein the storage device is configured to receive a partition generation command and a partition clearance command from a host, and
the storage device is configured such that the partition generation signal and the partition clearance signal are generated based on the partition generation command and the partition clearance command, respectively.

4. The storage device of claim 1, wherein the storage device is configured such that the partition generation signal comprises:
information corresponding to at least one of,
a physical address range of a physical area, to which each of the plurality of physical partitions is allocated, and
a memory size of each of the plurality of physical partitions.

5. The storage device of claim 1, wherein the storage device is configured such that the partition generation signal comprises:
information corresponding to one or more memory use characteristics of each of one or more of the plurality of physical partitions.

6. The storage device of claim 5, wherein the storage device is configured such that the one or more memory use characteristics include at least one of a ratio of an overprovisioning area and a wear level.

7. The storage device of claim 5, wherein the storage device is configured such that a value of the one or more memory use characteristics of at least one of the plurality of physical partitions is set to be different from that of a physical partition other than the at least one physical partition.

8. The storage device of claim 1, wherein the storage device is configured such that, based on an access request with respect to an access target logical partition from among the plurality of logical partitions being received at the storage device from a host,
the memory controller controls the nonvolatile semiconductor memory such that the access request is processed in an access target physical partition that is uniquely mapped with the access target logical partition, from among the plurality of physical partitions.

9. The storage device of claim 1, wherein the nonvolatile semiconductor memory further comprises:
at least one of a memory area mapped in common with two or more of the plurality of logical partitions and a memory area accessed regardless of the generated mapping information.

10. The storage device of claim 1, wherein the memory controller is configured to set an overall memory area of the nonvolatile semiconductor memory to be dynamically accessed, based on the partition clearance signal.

11. A storage device comprising:
a nonvolatile semiconductor memory including a memory area, the memory area including a plurality of different physical areas; and
a memory controller configured to generate partition mapping information describing a manner in which a plurality of logical partitions are mapped to a plurality of physical partitions,
the memory controller being configured to generate the partition mapping information based on a partition generation signal,
the plurality of logical partitions being uniquely mapped to the plurality of physical partitions, respectively,
the plurality of physical partitions corresponding to the plurality of different physical areas, respectively,
the storage device being configured such that,
after generation of the partition generation signal and before generation of a partition clearance signal, the memory controller controls the nonvolatile semiconductor memory to store received user data to be stored in a first logical address only in a first physical partition to which a first logical partition is mapped according to the partition mapping information, the first physical partition being a physical partition included in the plurality of physical partitions, the first logical partition being a logical partition in which the first logical address is included from among the plurality of logical partitions, and
after generation of the partition clearance signal, the memory controller controls the nonvolatile semiconductor memory to store received user data to be stored in the first logical address in a selected one of the plurality of physical partitions, the selected physical partition being chosen by the memory controller regardless of the partition mapping information.

12. The storage device of claim 11, wherein the memory controller is configured to use a memory allocation algorithm which does not allocate memory based on the partition mapping information to choose the selected physical partition.

13. The storage device of claim 11, wherein the memory controller is configured to receive a partition generation command and a partition clearance command from a host, and
the memory controller is configured to internally generate the partition generation signal and the partition clearance based on the partition generation command and the partition clearance command, respectively.

14. The storage device of claim 11, wherein the storage device is configured such that, after generation of the partition generation signal and before generation of the partition clearance signal, the first physical partition is not mapped with a second logical partition other than the first logical partition, the second logical partition being a logical partition included in the plurality of logical partitions.

15. The storage device of claim 11, wherein the storage device is configured such that, after generation of the partition generation signal and before generation of the partition clearance signal, the first logical partition is not mapped to a second physical partition other than the first physical partition, the second physical partition being a physical partition included in the plurality of physical partitions.
